(19) United States
(12) Patent Application Publication
(10) Pub. No.: US 2005/0112255 A1
(43) Pub. Date: May 26, 2005

(54) Apparatus and method for microbial intervention and pasteurization of food and equipment

(76) Inventors: Dennis E. Tottenham, San Antonio, TX (US); David E. Purser, San Antonio, TX (US)

Correspondence Address: KAMMER BROWNING PLLC, 7700 BROADWAY, SUITE 202, SAN ANTONIO, TX, 78209, US

(21) Appl. No.: 10/721,446

(22) Filed: Nov. 25, 2003

(51) Int. Cl. A23P 1/00

(52) U.S. Cl. 426/511

(57) ABSTRACT

The present invention discloses an apparatus and method for microbial intervention and pasteurization of food or equipment comprising a chamber, steam generator, superheater, controller, timer, power source, and temperature sensor. The temperature sensor and timer control exposure of the food or equipment to the superheated steam. After steam application, the food or equipment may be bathed by a chilled water source. The method for microbial intervention and pasteurization of the food and/or equipment surface includes: placing food or equipment in the chamber, adding superheated steam to the chamber until the surface temperature of the food or equipment is greater than a first preselected temperature, and maintaining the surface temperature by the continued application of superheated steam until the surface temperature is greater than a second preselected temperature.

### BACKGROUND OF THE INVENTION

1. Field of the Invention

The present invention generally relates to systems and methods for cleaning food and equipment, and more particularly, to a surface microbial intervention system and method that provide a 5-log (i.e., 100,000 times) reduction in the amount of microbial pathogens on the surface of food products and other items, such as food processing and medical equipment.

2. History of Related Art

Fruits, vegetables, and other foods are allowed to remain in contact with soil, insects, and animals during the time of their growth and harvest. Thus, fresh produce, for example, maintains populations of 10⁴ and 10⁵ microorganisms/gram when they arrive at the packing house. Such microorganisms include coliform bacteria, including Enterobacter, Klegsiella spp., and Escherichia coli. The bacteria population tends to remain relatively stable, with no significant influence exerted by temperature, total precipitation, or length of the day during harvest. Such bacteria may become natural contaminants of frozen concentrated fruit juices.

Since improperly handled food products and processing equipment can serve as a vehicle for the transmission of microorganisms to humans, the elimination of such surface bacteria and pathogenic microbes (which include spoilage organisms) has a tremendous value to the food and health industries. For example, there is currently a requirement by the Food and Drug Administration and the United States Department of Agriculture that all juice products include the following warning statement on package labels after Nov. 5, 1999. WARNING: This product has not been pasteurized and, therefore, may contain harmful bacteria that can cause serious illness in children, the elderly, and persons with weakened immune systems.

Thus, there are not only safety hazards afforded by the presence of these surface contaminants, but also marketing and legal implications.

Several approaches to reducing the number of bacteria on the surface of produce, food products, food processing equipment, and medical equipment have been attempted. Common chemical sanitizers, such as chlorine treatments, may be reasonably effective for equipment sanitation, but these chemicals apparently have little effect on microorganisms. Another approach includes steaming herbs, spices, and root/tuber vegetables under pressure, or in a vacuum. Chemical gases may be used to create an antiseptic environment. Each of these processes tends to be expensive and unreliable, fraught with an abundance of complicated equipment which tends to break down, and produce unpredictable results.

The technologies disclosed in U.S. Pat. Nos. 6,153,240, 6,264,889, and 6,350,482 are hereby incorporated by reference in their entirety. U.S. Pat. No. 6,153,240 issued on Nov. 28, 2000 to Tottenham et al. entitled APPARATUS AND METHOD FOR FOOD SURFACE MICROBIAL INTERVENTION AND PASTEURIZATION describes a method of placing food in a chamber, adding steam to the chamber until the surface of the food reaches a desired temperature, maintaining the surface temperature for a specified period of time or until the surface temperature of the food reaches a preselected temperature, and bathing the outer surface of the food with chilled water. This procedure greatly reduces the population of microorganisms on the surface of the food.

U.S. Pat. No. 6,264,889 issued on Jul. 24, 2001 to Tottenham et al. entitled APPARATUS AND METHOD FOR FOOD PROCESSING EQUIPMENT MICROBIAL INTERVENTION AND PASTEURIZATION discloses a specific embodiment of the pasteurization system wherein a stainless steel bonnet or cover is lowered over a piece of food. Steam enters the bonnet and is directed across the surface of the hood. The steam escapes through multiple outlets and drain pans in the bottom unit collect steam and particles from the equipment. Additional aspects of this technology are described in U.S. Pat. No. 6,350,482 issued on Feb. 26, 2002 to Tottenham et al. entitled APPARATUS AND METHOD FOR FOOD MICROBIAL INTERVENTION AND PASTEURIZATION which discloses the chamber as a tunnel with openings at either end for the continuous pasteurization of food on a roller conveyor which contains steam pipes with multiple outlets underneath the conveyor to surround the food with steam from several directions at once.

Some prior art methodologies required expensive and complicated steam generation equipment and often involved extended holding times which adversely affected the organoleptic properties of the food products so treated. The technology described in the above referenced Tottenham patents provides an apparatus and method which are inexpensive, mechanically simple, and which produce repeatable, reliable results. More specifically, the holding time for the food products to be surface pasteurized is consistently maintained at the minimum level necessary to accomplish a 5-log reduction in the amount of surface bacteria and/or microorganisms present on external surfaces of the food and processing equipment. A minimum number of steps to implement the process of such a method are required, and preferably, no special chemicals are introduced into the microbial intervention process.

However, the apparatus and method disclosed in the above referenced patents only provide 90 psi of steam pressure and heat chilled water to slightly below the boiling point, i.e., 212° F. This temperature is reduced by transit through pipes and into the chamber and once applied to an already cold product, it is reduced further (to about 170° F.). In addition, cold recharge water (60° or less) to generate more steam increases the amount of electricity required to manufacture the steam and further reduces the temperature. Adding heated water to the steam generator to get a higher steam temperature is not possible in a chilled processing plant. Moreover, most of the product in transit is chilled (40° F.) fruit or food items and with a tunnel system, additional latent heat is removed from the chamber where pasteurization is occurring. In certain instances, the heat can fluctuate to near or below the levels necessary for greatest bacterial kill resulting in insufficient pasteurization. Essentially, greater heat application than that provided by the steam generator is needed to boost the temperature in the chamber to much higher levels.

It is also desirable to greatly reduce the exposure time of the food to the steam for both production and efficiency. What is needed is a system which provides temperatures in the range of 65° to 232° C. Temperatures in this range further reduce the number of surface microorganisms present on the surfaces of the food or food processing equipment. Thus, what is needed is an apparatus and method which enable the use of a superheater which provides very high temperatures within the system without cooking or otherwise damaging the food or equipment contained within the system.

### SUMMARY OF THE INVENTION

By way of experimentation, it has been determined that the simplest method to accomplish microbial intervention at the surface of food products and processing equipment involves the use of steam and superheated steam. The present invention comprises an economically viable and mechanically robust apparatus adapted for microbial intervention and pasteurization of food and equipment surfaces comprising a chamber in fluid communication with a steam generator which is in turn connected to a controller and timer, a produce temperature sensor, and a power source. The present invention further comprises a superheater for circulation heating of gases, liquids, water, steam, or oils capable of boosting temperatures from 65° to 232° C., including ranges in between. This superheater apparatus utilizes an electric, gas, or other power source known in the art and has a control source, thermostat, piping, inlet and outlet connections, and thermostat control (either separate or controlled by a master controller device) that allows gases to be heated to a higher temperature under pressure than would normally be accomplished without a super heater.

The superheater provides additional temperature increases overall, to create sufficiently elevated temperatures such that the temperature reduction which occurs due to transit through the pipes and chamber and application to an already cold product does not result in a decreased system temperature to below levels necessary for optimum pasteurization. The use of the superheater also permits great reduction in the exposure time of the food to steam for both production and efficiency. It has been determined by both lab and industry application of superheated steam with delicate food items that more bacteria are killed if there is a higher heat with a shorter transit time. This also results in less time to cook the surface of the food or to cause quality degradation. Thus, more delicate items can be steam pasteurized with hotter steam and very short transit time.

The present invention utilizes a circulation or inline superheater that is thermostatically controlled and works in tandem with the primary steam generator. The use of superheated steam avoids degradation of organoleptic properties even though the temperature may be well above 100 degrees C. The higher heat temperatures of the steam are likely to kill more bacteria and preserve the quality of the food item due to less cooking and surface exposure to heat. When a medium changes state more energy is released. Therefore, the steam condensing transfers change of state energy to the bacteria in the form of heat, resulting in more pathogen-killing potential. The superheated steam is essentially free of liquid water, whereas steam (as that term is commonly used) is a mixture of water vapor and hot liquid water droplets. With superheated steam, the near absence of oxygen gas (as would be present in hot air) allows for higher product temperature without burning, resulting in faster sterilization. This is an important processing advantage, due to the fact that the superheated steam with minimal oxygen greatly reduces food oxidation, which is a major part of the cooking process. The use of superheated steam kills more thermoduric bacteria and some yeast and spores that are highly resistant to lower levels of heat. Thus, there are multiple advantages in the use of a superheated steam system.

A chilled water source may be present in the interior portion of the chamber, and is typically located above a suspension element (e.g., shelf or conveyor belt) which supports the produce or equipment above the bottom surface of the chamber interior. The water source provides water to bathe the produce or equipment at a (temperature from about 2 degree to about 5 degree C., if chilled). The source may be located in the interior portion of the chamber, or at the exterior of the chamber, depending on the particular process implemented, and the desires of the user. The water may include a sanitizing agent, including a suitable food and equipment grade sanitizer, such as chlorine, in quantities of about 3 ppm to about 400 ppm.

The steam generator has a steam pipe by which steam is conducted to the chamber. A water inlet valve allows water into the steam generator interior. The water inlet valve is in fluid communication with an orifice and a regulating valve, which ensures that the water volumetric flow never exceeds a preselected level.

The invention also includes a method for microbial intervention and pasteurizing the surface of food and equipment, such as food processing equipment and medical equipment, comprising the steps of placing the food or equipment in the chamber, adding steam or superheated steam to the chamber, sensing the temperature of the outer surface of the food or equipment, and adding steam or superheated steam to the chamber until the sensed temperature reaches a preselected temperature. The outer surface of the produce or equipment may be bathed with water chilled.

The temperature of the food or equipment surfaces may be sensed by placing a thermocouple inside of the steam pipe, delivering the steam to the chamber. This measurement serves as a safety step to measure the overall effectiveness of the steam application to the surface of the food or equipment to interpret the temperature of the chamber or product. Alternatively, the thermocouple can be inserted into the food to sense the temperature approximately 1/4 inch below the food surface. The temperature sensor (thermocouple) can either be wired to a computer or receiver or connected to a wireless transmitter for remote sensing by sensors known in the art.

The chamber may be structured as a tunnel with openings at either end for the continuous pasteurization of food on a roller conveyor. In this embodiment, the steam generator is connected to three steam pipes in the steam tunnel and one steam pipe underneath the roller conveyor. These pipes have multiple outlets in order to surround the food with steam from several directions at once. As the food exits the steam tunnel, the food may be sprayed with a chilled water bath from a chilled water source outside the tunnel.

The food processing equipment pasteurization system may be structured as a stainless steel bonnet or cover which is lowered over a piece of food processing equipment such as a meat slicer. The equipment sits on a bottom unit which includes a grated floor and drain pans. A steam inlet in the hood allows the steam to enter the bonnet. The steam is controlled by venting handles which allow excess pressure to escape. Steam flow is directed across the surface of the hood via multiple openings. The base unit also contains steam pipes with multiple outlets to allow steam to escape from the hood. Drain pans in the bottom unit collect steam and particles from the equipment.

### BRIEF DESCRIPTION OF THE DRAWINGS

A more complete understanding of the structure and operation of the present invention may be had by reference to the following detailed description taken in conjunction with the accompanying drawings, wherein:

FIG. 1 is a side-cut-away view of the microbial intervention and pasteurization apparatus of the present invention;

FIG. 2 is a schematic block diagram of the steam generator, superheater, and its related plumbing;

FIG. 3 is a flow chart which illustrates the method of the present invention;

FIGS. 4A, 4B, and 4C illustrate perspective, side cut-away, and top cut-away views, respectively, of the pasteurization steam tunnel and conveyor apparatus;

FIG. 5 is a schematic diagram of the pasteurization steam tunnel integrated with an industry system set-up;

FIG. 6 is a flow chart which illustrates the method of the invention for an industry system set-up utilizing the pasteurization steam tunnel;

FIGS. 7A and 7B illustrate perspective cut-away and side cut-away views, respectively, of the pasteurization apparatus designed as a steam containment unit; and

FIG. 8 is an inside view of the bottom of the steam containment unit.

### DESCRIPTION OF THE PREFERRED EMBODIMENTS

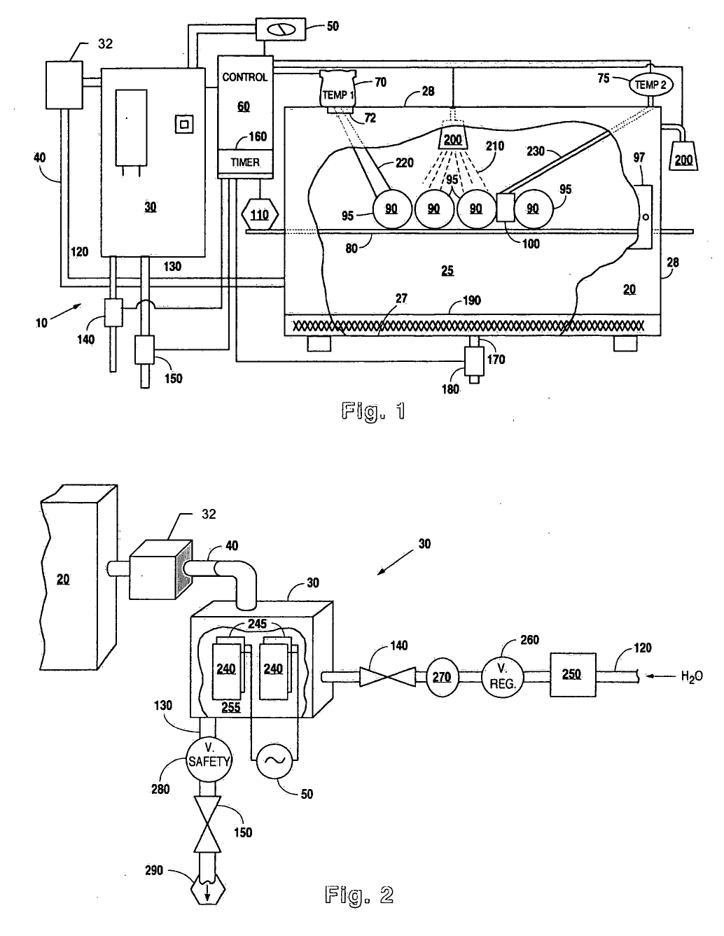

The microbial intervention and surface pasteurization apparatus 10 of the present invention can be seen in FIG. 1. The apparatus 10, which is adapted for surface microbial intervention and pasteurization of produce or food processing equipment 90 having an outer surface 95 comprises a chamber 20 with an interior portion 25. A source of chilled water 210, such as a water application nozzle 200 may be located at the interior portion 25, or at the exterior of the chamber 20. The chamber 20 includes a suspension element 80, such as a conveyor or shelf, which is adapted to support the produce or food processing equipment 90 above the bottom surface 27 of the chamber 20. This method of suspending the food or processing equipment 90 prevents contact with fluids 190 that may have come to rest at the bottom surface 27 of the chamber 20. Further, if the suspension element 80 is perforated, steam can more easily circulate around the outer surface 95 of the food or processing equipment 90, and drain properly onto the bottom surface 27 of the chamber 20. These fluids 19 may be drained from the bottom surface 27 of the chamber 20 by using the chamber drain 170, which is controlled by a drain valve 180.

A controller 60 is in electrical communication with several components or elements of the apparatus 10. Thus, the controller 60 operates the steam generator 30, several valves 140, 150, and 180; the conveyor drive 110 (if necessary); the chilled water source 200, and the superheater 32. The controller 60 also senses temperature by way of a remote temperature sensor 70, or a proximity temperature sensor 75 which makes use of a thermocouple 100 to measure the temperature of the surface 95 of the food or processing equipment 90. To sense temperature using the remote temperature sensor 70, a port 72, made of glass or other optically transparent material, may be introduced into the wall 28 of the chamber 20. The superheater 32 is controlled by the same controllers and thermostats as the steam generator 30.

The steam generator 30 is powered by the power source 50, which is also in electrical communication with the controller 60 and the timer 160. The controller 60 and timer 160 may be separate, or may form an integral unit.

The superheater 32 is located between the steam generator 30 and the steam outlet pipes 40 within the steam chamber 20 as shown in FIG. 1. The superheater's primary function is to boost the steam to a higher temperature than that obtained with the steam generator. FIG. 2 illustrates the superheater positioned between chamber 20 and steam pipe 40. The superheater 32 may be mounted horizontally or vertically after the steam generator 30. The superheated steam will generally be at temperatures of about 65° C. to about 232° C.

The steam generator 30 has a steam pipe 40 which is in fluid communication with the interior portion 25 of the chamber 20. Water is introduced into the steam generator 30 by the water pipe 120, which includes a water inlet valve, which is essentially in fluid communication with the interior portion of the steam generator 30. The steam generator also includes a backflush pipe 130 having a safety valve 150.

Turning now to FIG. 2, the steam generator 30 peripheral plumbing elements can be seen. Prior art steam generators used for food products often include inefficient and complex components. The steam generator 30 design of the present invention is simple, reliable, and has the capability to generate steam very quickly. The steam generator 30 makes use of one or more sets or series of plates, such as the first plate pair 240 and the second plate pair 245, connected to a power source 50 to generate steam. The addition of each set of plates increases the quantity of steam generated so that even water having poor conductivity can be used to produce adequate quantities of steam.

During operation, the interior portion 255 of the steam generator 30 is allowed to fill with water. The source of the water is the water pipe 120 that makes use of a filter 250 to provide strained water to the regulating valve 260. An orifice of about 0.033 inches diameter is placed in line with the water inlet pipe 120 to direct the water flow into the interior 255 of the generator 30, and a water inlet valve 140 is used to turn the flow of water on/off.

As the inlet valve 140 is turned on, water is allowed to flow through the water pipe 120, the filter 250, the regulating valve 260, and the orifice 270 into the interior portion 255 of the steam generator 30. The volume of water entering the generator 30, and thus the volume of steam generated, is adjusted by manipulating the regulating valve 260. The non-distilled water which enters the interior portion 255 of the generator 30 provides a complete electrical circuit between the first and second plate pairs 240, 245, or the heating coil element, allowing a current to flow between them. This current flow serves to heat the plates 240, 245, and generate steam within the generator 30. Since the backflush valve 150 on the backflush pipe 130 is closed at this time, the steam is driven into the steam pipe 40, enters the superheater 32 where the steam is boosted to a higher temperature, and then enters the chamber 20.

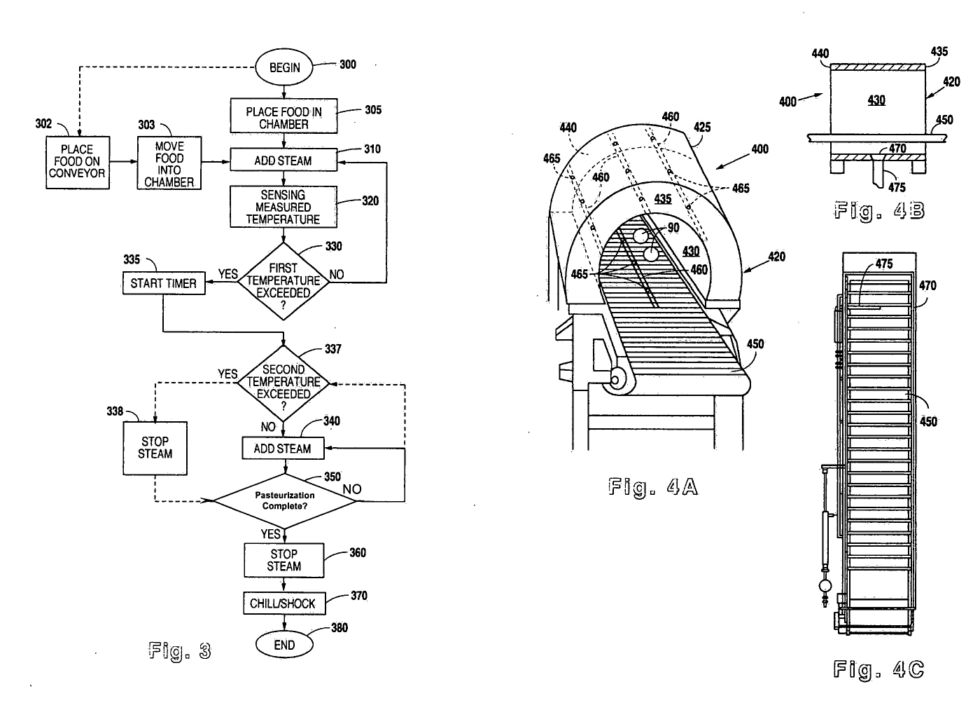

Turning now to FIG. 3, and reviewing FIG. 1, one possible embodiment of the method of the present invention can be visualized. The method begins at step 300 by placing food processing equipment or produce in the chamber at step 305 and adding superheated steam to the chamber at step 310. The measured temperature of the food or processing equipment outer surface is sensed at step 320 and a comparison is made as to whether the surface temperature is greater than some first preselected temperature, as shown at step 330. If not, temperature measurements continue to be made and more superheated steam is added until the surface temperature of the food or processing equipment is determined to be greater than or equal to the first preselected temperature.

After reaching the first preselected surface temperature, superheated steam is added to the chamber on a continuous basis until pasteurization has occurred. The amount of time required for proper pasteurization to occur is highly dependent on the type of food and its surface texture and is widely variable. For example, a delicate, thin-skinned product may require only five seconds for pasteurization, while a coarse, thick-skinned product may require several minutes for proper pasteurization to occur. This is illustrated in steps 335, 340 and 350. Steps 337 and 338 are optional, and the method may proceed directly from step 335 to step 340.

After the surface temperature of the food or processing equipment has reached the proper temperature, superheated steam is no longer added to the chamber, as shown in step 360. Testing verifies that this method consistently produces a 5-log reduction in the population of certain microorganisms and bacteria, mainly pathogens, on the surface of food. The outer surface of the processing equipment or food may be bathed with chilled water (about 2° to about 5° C.) if desired, or the product may be allowed to gradually return to normal temperature prior to packaging. Alternatively, the water may or may not be chilled, and may include chlorine, or some other suitable food and equipment grade sanitizing agent, in quantities of from about 3 ppm to about 400 ppm. The method ends at step 380.

As shown in FIG. 1, the temperature of the food or equipment 90 can be measured in several different ways. One alternative includes the use of a proximity temperature sensor 75 which is connected to a thermocouple 100 by an electronic temperature signal 230. The thermocouple 100 may be placed on the surface of the food or equipment 90, or located so as to sense the temperature of the food about 1/4 inch below the outer surface. Thus, the temperature may be measured on to the outer surface of food or equipment, or at some short distance beneath the outer surface of food.

Another measurement alternative includes the use of a remote temperature sensor 70 to obtain a temperature signal 220 from the surface of the food or equipment 90. The sensor 70 may operate through a port 72 if necessary. The signals from the remote temperature sensor 70, or the proximity temperature sensor 75 are recorded by the controller 60 and used to operate the steam generator 30, superheater 32, and timer 160. Non-contact methods of temperature measurement are preferred, since the possible transfer of organisms between food products using contact methods is obviated. If the suspension element 80 is a conveyor, then food or equipment 90 may be transported into and out of the chamber 20 using a conveyor drive 110. Otherwise, a door 97 may be used for direct access to the interior portion 25 of the chamber 20. As noted above, the source of chilled water 200, shown in FIG. 1 as a water application nozzle 200, may be located in the interior portion 25 of the chamber 20, or at the exterior of the chamber 20.

It should be noted that, while some prior art methods describe the application of steam to food products, there is no capability provided to prevent excessive heating of the food. It has been determined through experimentation that the application of steam which produces surface temperatures above about 84° C. for too long a period of time significantly affects the organoleptic properties of food products, and derivatives, such as juice. The instant invention, which includes the capability to measure the surface (or sub-surface) temperature of food may include additional steps to enhance the repeatability of microbial intervention and pasteurization results. For example, the method may include the steps of sensing the surface temperature of the food (or equipment, if desired) 90 so that, if temperatures greater than a second preselected temperature are detected, the steam generator 30 will be shut down so as to prevent further increases in surface temperature. Further, different food products may require different preselected temperatures for efficient microbial intervention and pasteurization, and the prevention of adverse effects to organoleptic properties. Thus, the method may include adjusting the surface temperatures to other, preselected temperatures based upon the particular food product. The method may also include the steps of placing the food or equipment 90 on a conveyor 80 as step 302, operating the conveyor drive to introduce the food/equipment 90 into the interior portion 25 of the chamber 20 at step 303, and continuing with the method illustrated in FIG. 3, at step 310.

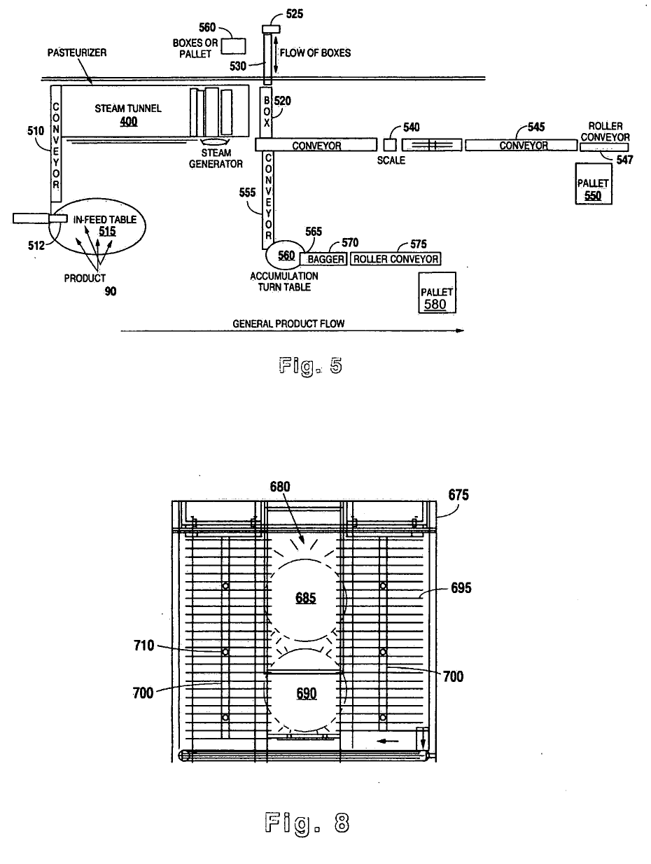

The pasteurization steam tunnel and conveyor apparatus can be seen in FIGS. 4A, 4B, and 4C. The apparatus 400 comprises a tunnel structure 420 having an outer surface 425, an inner surface 430, an anterior surface 435 and a posterior surface 440. The apparatus also includes a roller conveyor 450 which propels food 90 through the tunnel 420. The tunnel 420 contains multiple pipes 460 which extend the length of the tunnel 420 from anterior surface 435 to posterior surface 440. Each pipe 460 contains multiple openings 465 for the introduction of superheated steam through the inner surface 430 of the tunnel 420 to the food 90 on the conveyor belt 450. An additional pipe 460 runs beneath the roller conveyor 450. The pipe 460 contains multiple openings 465 for the introduction of superheated steam through the openings in the roller conveyor 450. The steam drains onto the bottom surface of the tank drain 470 located underneath the conveyor belt 450 wherein the water collects to drain through the tank drain pipework 475.

Turning now to FIG. 5, the schematic diagram of the pasteurization steam tunnel 400 integrated with an industry system set-up can be seen. This industry design allows the pasteurization steam tunnel 400 to be integrated into an efficient food processing system 500 whereby pasteurized foods are routed via additional conveyor belts into bags or boxes and onto pallets for transfer and delivery. The food 90 is loaded onto a roller conveyor 512 and transported to the in-feed table 515. Next, the food 90 is introduced into the pasteurization steam tunnel 400 (typically by means of another conveyor 510). After the food 90 is rolled out of the steam tunnel 400 and continues to the box loading ramp 520. The boxes 525 are taped at the taping station 530. The food 90 is loaded into the boxes 525, it continues via conveyor 535 to the scale 540 for weighing. The boxes 525 then continue via conveyor 545 to the roller conveyor 547 for transfer to one or more pallets 550. Alternatively, the food 90 is rolled out of the steam tunnel 400 and continues on the conveyor 555 to the accumulation turn table 560 where it is placed in bags 565 by the bagger 570. The bags 565 are transported on the roller conveyor 575 to one or more pallets 580 for transfer and delivery.

Thus, as shown in FIG. 6, the method of the invention may also include the steps of placing the food 90 on conveyor 510 in step 302A, operating the conveyor drive to move the food onto roller conveyor 512 at step 302B, moving the food 90 to the in-feed table 515 at step 302C, introducing the food 90 into the pasteurization steam tunnel 400 at step 303, and continuing with the method steps described in FIG. 3 (steps 310-370). In this embodiment, the method continues after step 370, wherein the food 90 may be chilled/shocked if desired, with steps 379A, 379B, or 379C whereby the food 90 proceeds via conveyor to either the boxes 525 in step 379A, the bagger 570 in step 379B, or the scales 540 in step 379C. Further processing may then occur in step 381.

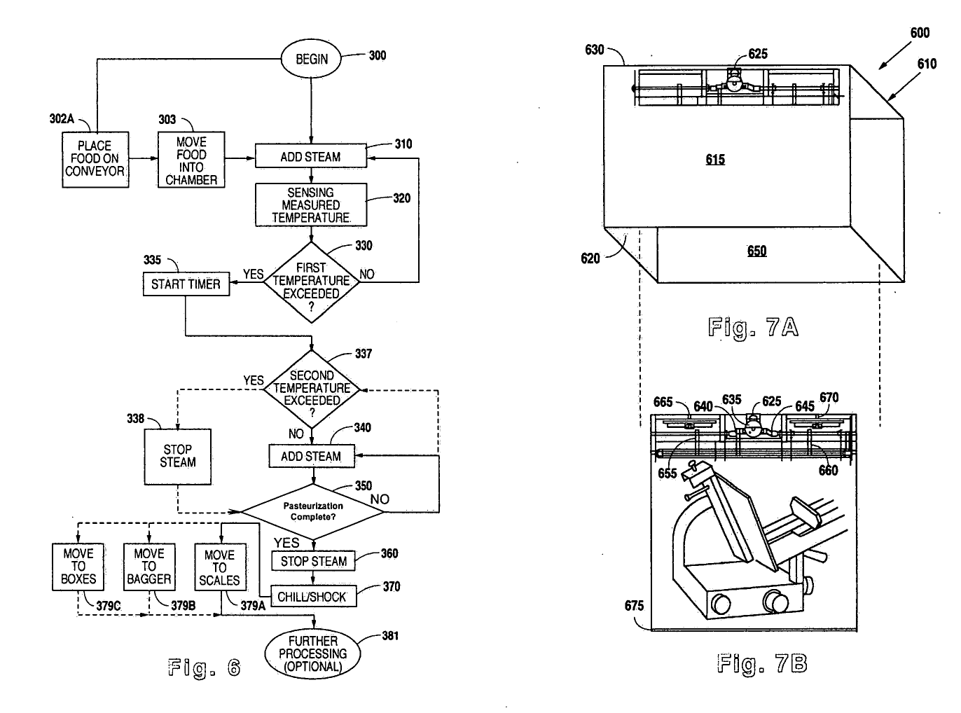

Turning to FIGS. 7A and 7B, the food equipment surface pasteurization system is illustrated as a steam containment unit or chamber 600. The apparatus includes a stainless steel bonnet or cover unit 610 and a bottom or base unit 675. The bonnet 610 has an outer surface 615 and an inner surface 620. The bonnet has one or more steam inlets 625 located in the top wall 630 of the bonnet 610. Superheated steam enters the bonnet 610 through the steam inlets 625 by a pipe 635. The pipe 635 is bifurcated into two smaller pipes 640 and 645 to allow the superheated steam to flow to both sides of the interior 650 of the bonnet 610. Directional steam flow devices 655 and 660 extend from the pipes 640 and 645 to introduce superheated steam into all areas of the bonnet interior 650. Two venting handles 665 and 670 are located in the top wall 630 of the bonnet 610 to facilitate regulation of the superheated steam pressure.

The bottom or base unit 675 can be seen in greater detail in FIG. 8. The bottom floor 680 of the base unit 675 slopes downwardly toward to drain pans 685 and 690. Suspended grates 695 extend across the bottom floor 680 in order to support food or food equipment. Superheated steam outlet pipes 700 are located along the bottom floor 680 under the grates 695. Multiple outlets 710 are placed along the outlet pipes 700 in order to allow superheated steam to escape into the interior 650 of the bonnet 610 at various positions.

Many variations and modifications may be made to the disclosed embodiments of the invention without departing from the spirit and principles described herein. All such modifications and variations are intended to be included within the scope of the present invention, as defined by the following claims.

1. An apparatus adapted for microbial intervention and pasteurization of food having an outer surface, comprising:
a chamber having a bottom surface, and a suspension element adapted to support the food above the bottom surface;
a superheater for circulation heating to temperatures from about 65° C. to about 232° C., having inlet and outlet connections and thermostat control;
a steam generator having a steam outlet pipe, and a water inlet valve, the steam outlet pipe being in fluid communication with the inlet of the superheater;
a controller operably connected to the water inlet valve, the steam generator and the superheater;
a timer operably connected to the controller and superheater;
a power source connected to the steam generator, the controller, the timer, and the superheater; and
a temperature sensor adapted to sense the temperature of the food or chamber where the food is exposed, the sensor being connected to the controller.

2. The apparatus of claim 1, wherein the chamber includes a drain.

3. The apparatus of claim 1, further including a chilled water source for bathing the produce.

4. The apparatus of claim 1, wherein the steam generator includes a backflush pipe having a safety valve.

5. The apparatus of claim 1, wherein the suspension element is a shelf.

6. The apparatus of claim 5, wherein the shelf is a porous shelf.

7. The apparatus of claim 1, wherein the suspension element is a conveyor.

8. The apparatus of claim 7, wherein the conveyor is a porous conveyor.

9. The apparatus of claim 1, wherein the controller and the timer form an integral unit.

10. The apparatus of claim 1, wherein the temperature sensor is a thermocouple.

11. The apparatus of claim 10, wherein the thermocouple is inserted into the steam pipe.

12. The apparatus of claim 10, wherein the connection between the thermocouple and the controller is wireless.

13. The apparatus of claim 1, wherein the temperature sensor is a remote electronic measuring device.

14. The apparatus of claim 1, wherein the chilled water source is located inside the chamber.

15. The apparatus of claim 1, wherein the chilled water source is located outside the chamber.

16. The apparatus of claim 1, wherein the steam generator includes a first set of plates and a second set of plates electrically connected to the power source.

17. The apparatus of claim 16, wherein the steam generator further includes an immersion heating element producing steam under pressure from about 30 pounds per square inch to about 100 pounds per square inch.

18. The apparatus of claim 1, where the superheater includes a flanged immersion heater, vessel, insulation, terminal enclosures, inlet and outlet water sources and connections, and an integral thermostat.

19. The apparatus of claim 1, wherein the water inlet valve is connected to an orifice.

20. A method for microbial intervention and pasteurization of food having an outer surface comprising the steps of:
placing the food in a chamber;
adding superheated steam to the chamber;
sensing a temperature of the food outer surface;
adding steam to the chamber if the measured temperature of the food outer surface is less than a preselected temperature, otherwise;
starting a timer having a timeout period;
adding steam to the chamber until the timeout period occurs; and
stopping the addition of steam to the chamber.

21. The method of claim 20, further including the step of bathing the outer surface of the food with chilled water.

22. The method of claim 20, wherein the step of sensing a temperature of the food outer surface is accomplished using a thermocouple placed in proximity to the food outer surface.

23. The method of claim 20, wherein the step of sensing a temperature of the steam within the steam outlet pipe is accomplished using a thermocouple placed within the steam outlet pipe.

24. A method for microbial intervention and pasteurization of food having an outer surface comprising the steps of:
placing the food in a chamber;
adding super heated steam of about 65° C. to about 232° C. to the chamber;
sensing a temperature of the steam inside the steam outlet pipe;
adding superheated steam to the chamber until the temperature of the food outer surface is greater than a first preselected temperature;
starting a timer having a timeout period; and
adding superheated steam to the chamber until the timeout period occurs, or the measured temperature of the food becomes greater than a second preselected temperature, whichever occurs first.

25. The method of claim 24, further including the step of bathing the outer surface of the food with chilled water after the timer reaches the timeout period.

26. The method of claim 24, wherein the step of sensing a temperature of the food about 1/4 inch below the food outer surface is substituted for the step of sensing a temperature of the steam within the steam outlet pipe, and wherein the step of adding superheated steam to the chamber until the measured temperature of the food about 1/4 inch below the outer surface is greater than a first preselected temperature is substituted for the step of adding superheated steam to the chamber until the temperature of the steam within the steam outlet pipe is greater than a first preselected temperature.

27. The method of claim 24, wherein the step of sensing a temperature of the food outer surface is accomplished using a thermocouple placed in proximity to the steam in the steam outlet pipe.

28. The method of claim 24, wherein the step of sensing a temperature of the steam in the steam outlet pipe is accomplished using a remote electronic sensing device.

29. An apparatus for microbial intervention and pasteurization of equipment having an outer surface, comprising:
a chamber having a bottom surface, and a suspension element for supporting the equipment above the bottom surface;
a superheater for circulation heating to temperatures from about 65° C. to about 232° C., having inlet and outlet connections and thermostat control;
a steam generator having a steam outlet pipe and a water inlet valve, the steam outlet pipe being in fluid communication with the inlet of the superheater;
a controller operably connected to the water inlet valve, the steam generator, and the superheater;
a timer operably connected to the controller and superheater;
a power source connected to the steam generator, the controller, the timer, and the superheater; and
a temperature sensor adapted to sense the temperature of the equipment outer surface, the sensor being connected to the controller.

30. The apparatus of claim 29, further including a chilled water source.

31. A method for microbial intervention and pasteurization of equipment having an outer surface comprising the steps of:
placing the equipment in a chamber;
adding super heated steam of about 65° C. to about 232° C. to the chamber;
sensing a temperature of the equipment outer surface;
adding superheated steam to the chamber until the temperature of the equipment outer surface is greater than a first preselected temperature;
starting a timer having a timeout period; and
adding superheated steam to the chamber until the timeout period occurs, or the measured temperature of the equipment outer surface becomes greater than a second preselected temperature, whichever occurs first.

32. The method of claim 31, further including the step of bathing the outer surface of the equipment with chilled water after the timer reaches the timeout period.
